(19) United States
(12) Patent Application Publication
(10) Pub. No.: US 2011/0126701 A1
(43) Pub. Date: Jun. 2, 2011

(54) RECIPROCATING PISTON ENGINE

(76) Inventors: Erich Kopp, Bad Homburg (DE); Frank Sieber, Aalen (DE); Jan Hinrichs, Friedrichsdorf (DE); Christian Heine, Mainz (DE); Michael Krug, Gau-Bischofsheim (DE)

(21) Appl. No.: 13/056,202

(22) PCT Filed: Jul. 17, 2009
(86) PCT No.: PCT/EP2009/005204

§ 371 Date: Jan. 27, 2011

(51) Int. Cl. F16J 1/00

(52) U.S. Cl. 92/172

(57) ABSTRACT

A reciprocating piston machine includes at least one piston movably supported within a cylinder bore. The reciprocating piston machine further includes a valve device interacting with the at least one piston. The valve device has a valve plate and a suction valve provided with a plurality of valve fingers.

The invention relates to a reciprocating piston machine as set forth in the preamble of Claim 1.

Reciprocating piston machines of the type discussed here are well known. They are employed, for example, as air-conditioning compressors, in particular to regulate the passenger cell temperature in motor vehicles. The reciprocating piston machines discussed here may relate to axial piston machines, but also to radial piston machines. Reciprocating piston machines of this type have at least one piston that is movable within a cylinder bore provided in a cylinder block. The reciprocating piston machines discussed here also have at least one valve device interacting with the at least one piston. The valve device has a valve plate and a valve, that is, a suction and/or a discharge valve, this valve having at least one valve finger, in particular, a plurality of valve fingers. The bottom of the suction valve and its valve fingers rest on a seating surface of the valve plate. Each valve finger covers one suction bore that provides the flow of refrigerant from a suction chamber into the cylinder bores accommodating the piston. In response to a movement of the piston within the cylinder bore away from the valve device, the suction force of the piston must overcome the adhesive force of the valve finger on the valve plate such that the valve finger finally releases from the valve plate and unblocks the suction bore such that refrigerant flows into the cylinder bore. Some refrigerants require the diameter of the suction bore to be restricted, with the result that the pressure on the valve finger from the suction chamber side is diminished and a consequently greater adhesive force must be overcome. In the case of these reciprocating piston machines in particular, what has been found is that the suction force by the piston, or the suction pressure within the cylinder bore, is often insufficient to overcome the adhesive force of the valve finger against the valve plate, that is, so as to release the valve finger from the valve plate and thus unblock the suction bore. As a result, the reciprocating piston machine has poorer startup properties and reduced efficiency.

In known reciprocating piston machines of prior art, the roughness of the contact surface between the valve fingers and the valve plate is enhanced so as to enable the adhesive forces to be overcome more easily. This approach reduces the contact surface area, and thus also the adhesive forces, are reduced that interact between the valve finger and the valve plate. The roughness is typically enhanced by surface treatment techniques, such as sand-blasting, needling or stamping, or by etching. One disadvantage of these methods is that they are difficult to control, and it is not possible to create a precisely-defined structure to generate a predefined roughness of the surface.

The object of this invention is therefore to create reciprocating piston machine in which a previously defined structure is able to be incorporated in a simple and precisely defined fashion.

In order to achieve this object, a reciprocating piston machine is proposed that has the features of Claim 1. The machine is distinguished by the fact that a structure in the form of depressions and/or raised areas in the valve finger and/or in the valve plate is provided in at least one region in which the at least one valve finger rests on the valve plate, and that the structure is produced by a laser process. The advantageous incorporation of the structures in the valve finger and/or in the valve plate by a laser process enables the structure, in particular, the depth of the depressions and the height of the raised areas, and thus the roughness of the surface, to be determined precisely ahead of time, and thus enables optimal surface properties to be created in the contact region between valve finger and valve plate, which properties at least diminish the adhesive forces. The depressions and raised areas produced by the laser process are furthermore are able to be produced quickly and inexpensively during the laser process. In addition, the laser process enables precisely defined structures of small size to be created that cannot be implemented by using conventional methods.

What is preferred in particular is an embodiment of a reciprocating piston machine that is distinguished in that on each side a depression is immediately adjacent to a raised area. A structure formed in this way is especially easy to produce by using a laser process since only the power of the laser must be adjusted to the appropriate level so as to allow the material from the depression to accumulate at the side thereof in the form of raised areas.

What is also preferred in particular is an embodiment of a reciprocating piston machine that is distinguished in that the structure is of a grid-like design. This approach enables a structure of relatively large area to be generated that has depressions and raised areas.

What is preferred in particular is another embodiment of a reciprocating piston machine that is distinguished in that the structure has multiple point-like depressions. The raised areas are then preferably formed in ring-shaped fashion and disposed concentrically relative to point-like depressions. The spacing between individual point-like depressions, or ring-shaped raised areas can vary here depending on requirements.

What is preferred in addition is an embodiment of a reciprocating piston machine that is distinguished in that the structure is disposed, at least in part, around a suction opening of the valve plate, which is intermittently closed by the valve finger. It is critical specifically in the region around the suction opening that the adhesive forces be overcome even in response to small suction forces. The arrangement of the structure in the region around the suction opening provides the optimal conditions to achieve this.

What is preferred finally is an embodiment of a reciprocating piston machine that is distinguished in that an structure-free ring-shaped region in which the valve finger rests creating a seal against the valve plate. This prevents a short circuit from being created between the suction chamber and the cylinder bore.

The following discussion describes the invention in more detail based on the drawing. In the drawing:

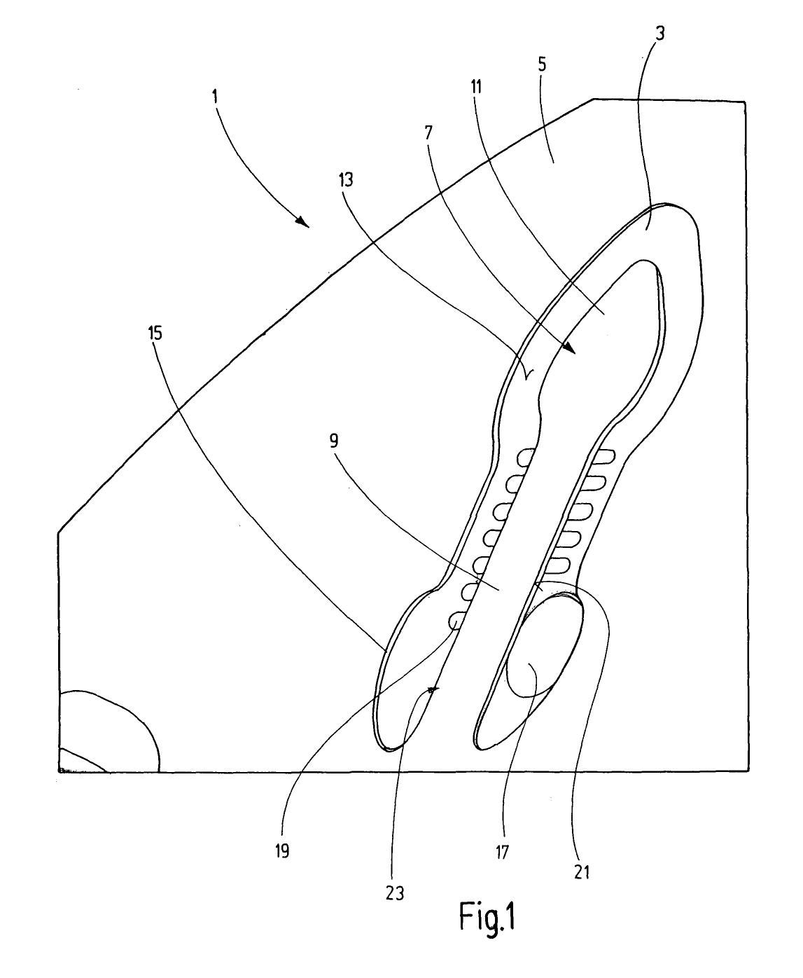

FIG. 1 is a perspective view of one region of a valve device;

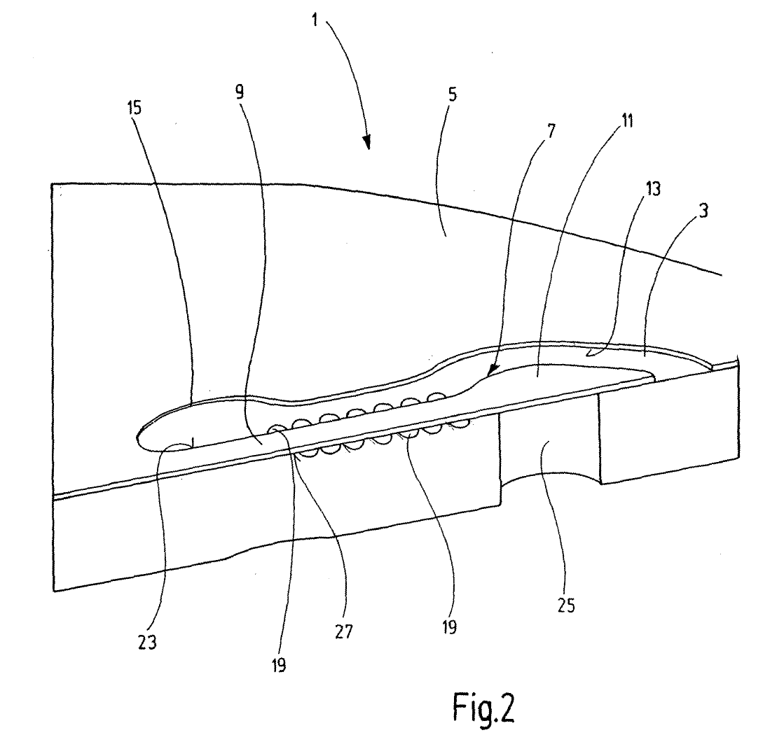

FIG. 2 is a section through the valve device of FIG. 1;

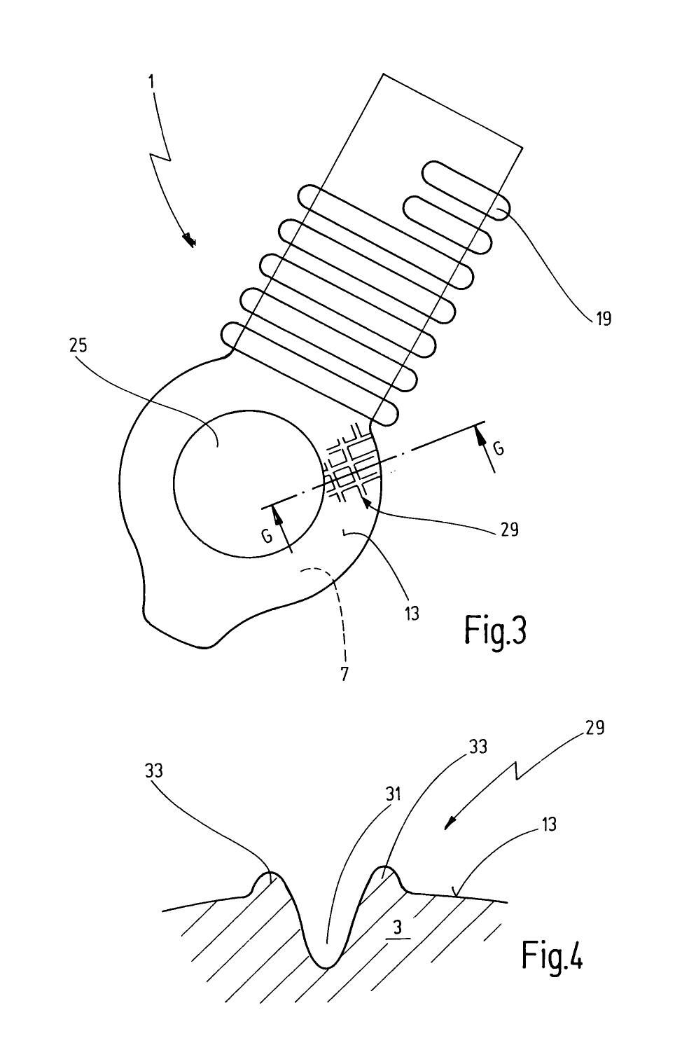

FIG. 3 is a valve device including a structure according to the invention; and

FIG. 4 is an enlarged sectional view of the structure in FIG. 3 along cut line G-G.

FIG. 1 is a perspective view of one region of a valve device 1 of a reciprocating piston machine. Valve device 1 has a valve plate 3 and a plate-shaped valve suction valve 5, here shown simply by way of example. It is understood that the invention can be equally applied in the case of a discharge valve.

Valve device interacts here with a piston, not shown here, that is movably supported within in cylinder bore. In response to movement of the piston within the cylinder bore away from the valve device, suction forces are created that must overcome the adhesive force of at least one valve finger 7 against valve plate 3 in order to release valve finger 7 from valve plate 3 and unblock a suction bore, not shown here. Due to requirements of the production process, which preferably comprises a stamping process, the at least one valve finger 7 is preferably of a one-piece integrated design.

Suction valve 5 preferably has a plurality of valve fingers 7, one each of which is associated with a suction bore. A piston supported within a cylinder bore is also associated with each valve finger 7.

Valve finger 7 comprises a valve finger arm 9 and a valve finger head 11. Valve finger head 11 covers the suction bore, not shown here, which with the suction valve ensures a fluid communication between a suction region and the cylinder bore when in the opened state, that is, whenever valve finger head 11 is not covering the suction bore. Suction valve 5 and its plurality of valve fingers 7, only one of which is shown here, rests on a seating surface 13 of valve plate 3.

In order to ensure that valve finger 7 can freely move independently of the rest of suction valve 5, a recess 15 is provided within suction valve 5 around valve finger 7. In addition, an outlet bore 17 is disposed in valve plate 3 in the region of recess 15, the outlet bore creating a fluid communication between the cylinder bore and a pressure chamber separated from the suction region.

A discharge valve, not shown here, which also has valve fingers that close outlet bore 17, is disposed on the surface of valve plate 3 opposite seating surface 13. Whenever the piston within the cylinder bore moves towards valve system 1, the discharge valve, not shown here, is forced away from the surface of valve plate 3 opposite seating surface 13 by the pressure of the compressed refrigerant, thereby enabling the refrigerant to flow between the cylinder bore and the pressure chamber.

As was already explained above, in order to open suction valve 5, that is, to lift valve finger 7 from the not-shown suction bore under valve finger head 11, adhesive forces must be overcome that exist between valve finger 7 and seating surface 13 of valve plate 3. The adhesive force between valve finger 7 and seating surface 13 is proportionately greater the greater is the support surface of valve finger 7 on valve plate 3. What is understood by the term support surface here is the sum of the regions in which valve finger 7 and valve plate 3 are in contact.

For certain refrigerants, in particular, gaseous ones, it is necessary to provide the suction bore with a smaller diameter. As a result, the force acting on the bottom side of valve finger 7, which side is not visible here, is reduced by the refrigerant present in the suction chamber. In commensurate fashion, the adhesive force increases between valve finger 7 and seating surface 13, which force must be overcome by the suction force of the piston.

In order to improve the startup properties, multiple grooves 19 are provided in valve plate 3 illustrated in FIG. 1, these grooves diminishing the support surface for valve finger 7 on seating surface 13. Grooves 19 are preferably provided in the region of valve finger arm 9. Another conceivable approach, however, is to dispose grooves 19 in the region of valve finger head 11. The critical aspect here is for grooves 19 not to be in communication with the suction bore, not visible here, since this would otherwise result in a short circuit between the suction chamber and the cylinder bore.

Groove 19 is of elongated design and extends within valve plate 3 over the entire width of valve finger arm 9, and extends beyond the arm's lateral edges 21 and 23. Groove 19 provided in valve plate 3 thus communicates on one side with the cylinder bore adjoining valve device 1, and on the other side is disposed between valve finger 7 and valve plate 3, or is covered by valve finger 7.

As a result, refrigerant is able to move more easily through grooves 19 from the suction chamber, which refrigerant essentially flows under the bottom side of valve finger 7, that is, the side of valve finger 7 resting on seating surface 13. Thus relatively lower adhesive forces that are present between valve finger 7 and valve plate 3 must be overcome—on the one hand, due to the under-flow and, on the other hand, due to the relatively smaller support surface of valve finger 7 on seating surface 13 of valve plate 3. As a result, the startup behavior and efficiency of the reciprocating piston machine are significantly improved.

FIG. 2 illustrates a section through valve device 1 of FIG. 1. Identical parts are provided with identical reference numerals, and thus reference is made to the description relating to FIG. 1 as to avoid repetitions whenever.

Seen in FIG. 2 is the suction bore 25 that is covered by valve finger head 11 of the valve finger and to which a suction chamber connects on the opposite side of suction valve 5, from which chamber refrigerant to be compressed is intended to flow through suction bore 25 into the cylinder bore.

FIG. 2 once again highlights the fact that the at least one groove 19 on the one hand communicates with the cylinder bore and on the other hand is covered in particular by valve finger arm 9 of valve finger 7. In the event that grooves 19 are located in bottom side 27 of valve finger 7, groove 19 is covered by valve plate 3.

FIG. 3 illustrates a valve device having a structure 29 according to the invention. Identical parts are provided with identical reference numerals and so reference is made to the description relating to the previous figures. Valve finger 7 is only indicated by reference but not shown in FIG. 3.

In FIG. 3, structure 29 is of a grid-like design, simply by way of example, and is disposed in part around suction bore 25 in valve plate 3 that is intermittently closed by valve finger 7. Another conceivable approach is for suction bore 25 to be almost completely surrounded by structure 29. A structure-free ring-shaped region is preferably provided directly around suction bore 25, in which region valve finger 7 rests against valve plate 3 creating a seal. The fact that the ring-shaped sealing region preferably completely surrounds suction bore 25 prevents any short circuit between the suction chamber and the cylinder bore. Valve finger head 11 then preferably rests almost completely on structure 29.

Another conceivable approach aside from the above is for structure 29 to have point-like depressions, relative to which one ring-shaped raised area each is disposed concentrically. A laser could thus use a point-like mode to work contact surface 13 of valve plate 3, or bottom side 27 of valve finger 7. The material displaced from the depression during the laser process then forms a ring-shaped raised area.

In overall terms, structure 29, which has been incorporated by laser 29, enables a precisely-defined roughness to be generated that prevents, or at least minimizes, any “sticking” of valve finger 7 to valve plate 3. The roughness of the surface enables the surface area to be reduced in which valve finger 7 and valve plate 3 contact each other. Simply by way of example, structure 29 is incorporated in seating surface 13 of valve plate 3. Another conceivable approach, however, is to incorporate structure 29 into the bottom side of valve finger 7 that rests intermittently on seating surface 13. The only critical aspect is to produce this structure by laser in a precisely defined manner.

Structure 29 proposed here is generated by a laser process. This enables especially fine and precisely-defined structures to be created that can have virtually any shape. Unlike known methods, the use of a laser process to generate the adhesion-diminishing structures has the advantage of being inexpensive, fast, and capable of being performed quickly.

Provision can also be made whereby structure 29 extends beyond the region in which valve finger 7 rests on valve plate 3. This enables the same positive effects of grooves 19 to be achieved.

Provision can also be made whereby structure 29 is provided exclusively, or also additionally, in valve finger 7, as was already described above. In this case, structure 29 can extend up to the lateral edge 21 of valve finger 7. Obviously, structure 29 can also be disposed in the region of valve finger arm 9 in valve finger 7, or in valve plate 3.

The following discussion uses FIG. 4 to describe in more detail structure 29 that is generated by laser.

FIG. 4 is an enlarged sectional view of structure 29 in FIG. 3 along cut line G-G. Identical parts are provided with identical reference numerals and so reference is made to the description relating to the previous figures.

The sectional view of FIG. 4 clearly illustrates that structure 29 has depressions 31 and raised areas 33, these either extending below, or respectively above, seating surface 13 of valve plate 3. In structure 29 shown in FIG. 4, raised areas 33 are provided at both sides of depressions 31, these raised areas being formed by material that is displaced from depressions 31 during the laser process.

In sum, it has been found that the use of a laser process to incorporate structure 29 that has depressions 31 and raised areas 33 is especially effective. This approach enables any desired precisely-defined structures, and thus a precisely-defined surface roughness, to be created inexpensively and quickly, which can be precisely incorporated in seating surface 13 of valve plate 3 and/or in the bottom side of valve finger 7.

The methods known from the prior art for incorporating rough structures in a surface only allow for an undefined introduction of structures that are generated by indiscriminate material processing techniques—that is, noncontrollable chemical or physical ones such as, for example, etching or sand-blasting processes. It is thus not possible with these methods to define precisely in advance which structure should be generated so as to generate the optimum roughness for diminishing the adhesive forces between valve finger 7 and valve plate 3.

On the other hand, the use of a laser process to generate an adhesion-preventing structure enables the creation of an optimized, precisely-defined structure that has a previously defined roughness, which in turn can be optimally adapted to any given requirements.

The desired depth of depressions 31 or the height of raised areas 33, and thus the desired roughness, can be easily adjusted as appropriate through the power of the laser that also has a suitable wavelength. The focal point of the laser beam can furthermore be adjusted so as to enable very small structures to be created.

It has been found that the use of a laser process to create adhesion-diminishing structures in valve plate 3 and/or in valve finger 7 is especially advantageous.

It is obvious that this invention can also be employed in analogous fashion in the case of similar valve applications in other fluid machines, in particular, hydraulic and pneumatic machines.

### LIST OF REFERENCE NUMERALS

1 valve device
3 valve plate
5 suction valve
7 valve finger
9 valve finger arm
11 valve finger head
13 seating surface
15 recess
17 outlet bore
19 groove
21 side wall
23 side wall
25 suction bore
27 bottom side
29 structure
31 depression

1-7. (canceled)

8. A reciprocating piston machine for motor vehicles, the reciprocating piston machine comprising:
at least one piston that is movably supported within a cylinder bore;
a valve device interacting with the at least one piston, that valve device having a valve plate and a valve provided with at least one valve finger; and
a structure in the form of depressions and/or raised areas is provided in the valve plate and/or in the valve finger, at least in one region in which the at least one valve finger rests on the valve plate, the structure produced by a laser process.

9. The reciprocating piston machine according to claim 8, wherein the structure includes a raised area immediately adjacent to each side of a depression.

10. The reciprocating piston machine according to claim 8, wherein the structure is of a grid-like design.

11. The reciprocating piston machine according to claim 8, wherein the structure has multiple point-like depressions.

12. The reciprocating piston machine according to claim 8, further comprising ring-shaped raised areas disposed concentrically relative to the point-like depressions.

13. The reciprocating piston machine according to claim 8, wherein the structure is disposed at least partially around a suction bore of the valve plate, which is intermittently closed by the valve finger.

14. The reciprocating piston machine according to claim 8, further comprising a structure-free, ring-shaped region immediately around the suction bore, the valve finger resting in this region on a valve plate so as to create a seal.
